(19) United States
(12) Patent Application Publication
(10) Pub. No.: US 2026/0237625 A1
(43) Pub. Date: Aug. 13, 2026

(54) AUTOMATED SAMPLE ANALYSIS SYSTEM AND METHODS OF USE THEREOF

(71) Applicant: Purdue Research Foundation, West Lafayette, IN (US)

(72) Inventors: Robert Graham Cooks, West Lafayette, IN (US); Eric T. Dziekonski, Lafayette, IN (US)

(21) Appl. No.: 19/153,784

(22) PCT Filed: Jan. 25, 2024
(86) PCT No.: PCT/US2024/012905

§ 371 Date: Aug. 5, 2025

Related U.S. Application Data
(60) Provisional application No. 63/444,690, filed on Feb. 10, 2023.

(51) Int. Cl. H01J 49/16; H01J 49/00

(52) U.S. Cl. CPC H01J 49/165; H01J 49/004

(57) ABSTRACT

The invention generally relates to an automated sample analysis system and methods of use thereof. In certain aspects, the invention provides an automated sample analysis system comprising: a desorption electrospray ionization (DESI) probe; a substrate for holding one or more samples; a mass spectrometer; and one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition.

### RELATED APPLICATION

The present application claims the benefit of and priority to U.S. provisional patent application No. 63/444,690, filed Feb. 10, 2023, the content of which is incorporated by reference herein in its entirety.

### GOVERNMENT SUPPORT

This invention was made with government support under W15QKN-18-9-1004 awarded by the Department of Defense, and Agreement No. 20CWDAR100039-01 awarded by the United States Department of Homeland Security. The government has certain rights in the invention.

### FIELD OF THE INVENTION

The invention generally relates to an automated sample analysis system and methods of use thereof.

### BACKGROUND

High-throughput experimentation (HTE) is accelerating the discovery of new drug molecules and deepening our understanding of biological systems. In addition to the high accuracy and sensitivity demanded of modern methodologies and instrumentation, this approach seeks to perform rapid analysis of large sample sets with a high degree of chemical specificity. In the past, surface enhanced Raman spectroscopy, surface plasmon resonance, UV-Vis, and especially fluorescence have been the methods of choice in HTE, but their limitations in terms of chemical specificity are becoming increasingly clear. Alternatively, many HTE workflows are now incorporating mass spectrometry (MS) because of its speed, accuracy, sensitivity, and chemical specificity, with the barrier for entry being minimized by commercial solutions such as various systems by Agilent. Example sample dispensing methods for these HTE-MS systems include acoustic droplet ejection, solid phase extraction, and self-assembled monolayers for matrix assisted laser desorption/ionization-mass spectrometry (SAMDI-MS).

Ambient ionization techniques, such as desorption electrospray ionization (DESI), avoid the need for sample purification prior to analysis. DESI-MS specifically is advantaged over other methods as it is contact-less, requires low-microliter sample volumes, nmol/spot sample concentrations, and is capable of reaction acceleration in microdroplets. Extensions of HTE using DESI-MS include the online screening of large numbers of reaction conditions for the synthesis of active pharmaceutical ingredients, high-throughput screening of late-stage functionalization of drug molecules and label free measurement of enzyme kinetics. Additional information becomes available if there are underlying connections between the sample spots e.g. (i) they constitute a biological tissue section, (ii) they represent successive time points in a kinetic experiment, or (iii) they represent output of a chromatographic separation, where temporal relationships are converted into spatial relationships in (ii) and (iii). Once again, commercial interest in the HTE DESI-MS space has seen the introduction of the desorption electrospray ionization (DESI) XS ion source, manufactured by Waters. Unfortunately, most commercial instrumentation is tailored for a specific platform and is therefore not directly amenable to novel methodologies or instrumentation which is independently developed, such as 2D-MS/MS.

Two-dimensional tandem mass spectrometry (2D-MS/MS) provides a rapid untargeted approach to complex mixture analysis by acquiring the full 2D-MS/MS data domain of all precursor ions falling within a specified m/z range using a single ion population. This experiment can be conveniently performed in a single quadrupole ion trap and the simplicity of implementation and high speed of data acquisition offset the limited mass resolution. In a coupled analysis, the individual capabilities of high throughput DESI and 2D-MS/MS are retained but the combination provides new capabilities and applications. These are expected to include improved DESI imaging of biological samples (e.g. tissue sections) where trends in ion intensity as a function of sample number could, for example, represent a z-dimension increment. Other instances could include the kinetic information inherent in a time-course set of samples, such as bacterial growth or reaction kinetics. Previously, DESI was coupled to 2D-MS/MS to perform high-throughput screening of bacterial whole cell lysates to monitor changes in the lipidome over time, however, data acquisition by the Thermo LTQ and sample movement by the Prosolia DESI 2D system were not inherently synchronized; a consequence of using commercial products from differing vendors. Without careful consideration of the experimental timing parameters between the two independent systems, this could easily lead to incorrectly reported sample positions or missed samples, both of which have major implications on HTE or imaging analysis quality.

### SUMMARY

The invention provides the design, construction, and software development for a fully integrated and automated DESI-2D-MS/MS platform which is utilized to perform the high-throughput acquisition of the full 2D-MS/MS data domains of several model mixtures. The methodology utilizes synchronous movement of a two-dimensional X/Y stage with the 2D-MS/MS acquisition, thereby ensuring that all workflow segments are performed at the correct time and position. The submicron mechanical precision offered by the stage and stepper motor controller is sufficient to analyze 6,144 well plates or perform DESI imaging experiments.

In certain aspects, the invention provides an automated sample analysis system comprising: a desorption electrospray ionization (DESI) probe; a substrate for holding one or more samples; a mass spectrometer; and one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition.

In other aspects, the invention provides methods for automated sample analysis that involve providing an automated sample analysis system comprising a desorption electrospray ionization (DESI) probe; a substrate for holding one or more samples; a mass spectrometer; and one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition; and operating the system to analyze one or more samples and generated a 2D-MS/MS image for each sample in an automated and synchronized manner.

In certain embodiments of the systems and methods herein, the one or more programs control timing and flow of data acquisition/processing throughout data acquisition. In certain embodiments of the systems and methods herein, the one or more programs ensure that data acquisition is performed at a specified point on the substrate.

In certain embodiments of the systems and methods herein, at each collection point, three spectra are acquired and averaged while the substrate is continuously oscillated from a defined spot center. In certain embodiments of the systems and methods herein, the oscillatory motion increases spectral reproducibility by mitigating a coffee ring effect, wherein spotted samples show higher concentration of an analyte around an outer edge of a dried spot.

In certain embodiments of the systems and methods herein, upon completion of raw data acquisition, the one or more programs average one-dimensional raw data so that it is reshaped by splitting a recorded time domain into equal length segments corresponding to a duration of a single product ion sweep to generate product ion spectra. In certain embodiments of the systems and methods herein, each of the product ion spectra are then placed into their respective two-dimensional table column to generate an image. In certain embodiments of the systems and methods herein, wherein each two-dimensional time-domain spectral image was calibrated for precursor and product ion mass/charge ratio from recorded peak positions, sweep time, and/or precursor or product scan rate.

In certain embodiments of the systems and methods herein, the automated sample analysis system comprises a plurality of controllers, each associated with a different aspect of the system and each in communication with each other. In certain embodiments of the systems and methods herein, one of the plurality of controllers is a master controller.

### BRIEF DESCRIPTION OF THE DRAWINGS

FIGS. 1A-B show an embodiment of the systems of the invention. Left: Sample loading of the PTFE coated microscope slide used for DESI analysis. The uncoated array of spots served as a position guide. Each respective sample loading position, ‘x’, is assigned a numerical value 1-8. The TAA mixture was loaded in positions 1 and 5, the atenolol/fendiline mixture in positions 2 and 6, and the fentanyl mixture in positions 3 and 7. Spots 4 and 8 were left as blanks. The triangle indicates the idle/starting point of the DESI sprayer along the surface. Right: Experimental setup depicting the 2D translational moving stage, DESI sprayer, and PTFE sample substrate. The entire setup is mounted to the front of the LTQ-XL mass spectrometer using the channels normally reserved for an ion source.

FIG. 2 is a schematic showing that to bypass instrument control of the RF voltage applied to the linear ion trap, the trace between the electrical via and TP25 was severed. A custom RF control signal was applied to TP25.

FIG. 3 shows an experimental connection and communication diagram. Single-headed arrows denote one-way communication, whereas double-headed arrows denote bidirectional communication. For these experiments, control is passed between the various components in a serial manner, with the one exception being for control of stage oscillation during data acquisition.

FIG. 4 shows effect of tone-mapping on the spectrum of TAA's recorded at spot 4. The left image uses a global linear colormap (default), whereas the right image uses tone-mapping and local colormaps to increase the perceived image contrast.

FIG. 5 shows DESI-2D-MS/MS spectra of three different mixtures spotted on a PTFE slide. The number in the upper left indicates the position of the spot on the slide. All constituents are easily identified by their precursor mass-to-charge ratios, while their product ion spectra could be extracted for additional information.

FIG. 6 shows how one might obtain a traditional MS¹ or MS² spectrum from the two-dimensional datasets of FIG. 5 Using spot one as an example, Left: Conventional MS¹ spectrum generated by projecting (summing) the intensities of each column in the 2D-MS/MS spectrum to the precursor m/z axis. Right: Conventional MS² spectrum of THPA, generated by extracting the column with the maximum intensity near precursor m/z=410.5. The raw, time-domain, dataset was smoothed with a Gaussian filter (length=5, iterations=2) to suppress any high frequency features.

FIG. 7 is an illustration showing an exemplary data analysis module for implementing the systems and methods of the invention in certain embodiments.

### DETAILED DESCRIPTION

Two-dimensional tandem mass spectrometry (2D-MS/MS) provides rapid unsupervised access to all product ions of all ionized precursor ions. In this study, desorption electrospray ionization is used to create ion populations from complex mixtures prior to the use of 2D MS/MS to characterize each sample in an array. Automated high-throughput examination of each sample in the array is achieved by integrating movement of the sample array with automated acquisition of data from each sample through a serial handshake procedure. Position control is achieved using an Arduino microprocessor, a RAMPS control board, two stepper motors, and a custom MATLAB graphical user interface. Data processing improvements to the 2D-MS/MS workflow included optimizing the contrast of the intensity distribution of individual precursor to product ion transitions in local regions of the 2D spectrum to enhance visual discrimination of peaks from the background. This study demonstrates the combination of several advanced capabilities for practical mass spectrometry including high throughput experiments on unmodified samples with unconstrained sample acquisition and fully automated instrumental control and data manipulation. These capabilities are demonstrated with several model mixtures spotted on a PTFE-coated substrate, where the total analysis time was 64 seconds. Details of the system and discussion of the system performance are provided.

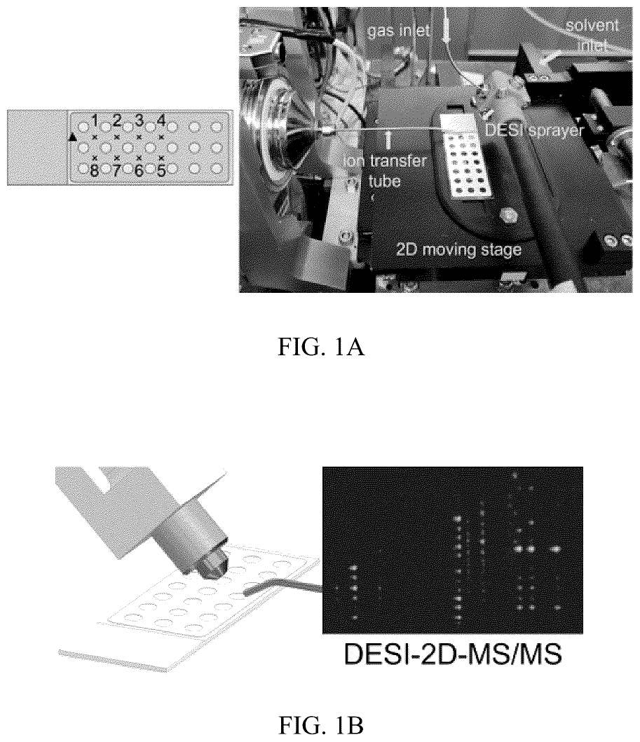

FIGS. 1A-B illustrates an embodiment of the systems of the invention. As shown in FIG. 1A, the systems of the invention include a desorption electrospray ionization (DESI) probe; a substrate for holding one or more samples; a mass spectrometer; and one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition.

The following chemicals were purchased from Sigma-Aldrich (St. Louis, MO, USA): tetrabutylammonium bromide (TBA), tetrapentylammonium bromide (TPA), tetrahexylammonium bromide (THA), tetraheptylammonium bromide (THPA), tetraoctylammonium bromide (TOA), fentanyl, cyclopropyl fentanyl hydrochloride, furanyl fentanyl hyrdochloride, atenolol, fendiline hydrochloride, and formic acid (FA). Methanol (MeOH) was purchased from Thermo Fisher Scientific (Pittsburgh, PA, USA). Deionized water was generated on-site with a Milli-Q® Direct-Q® 3 UV Water Purification System. The tetraalkylammonium (TAA) mixture, consisting of all five of the salts mentioned above, was prepared to a final concentration of 0.5 μM each in MeOH. The fentanyl mixture, consisting of fentanyl, cyclopropyl fentanyl, and furanyl fentanyl, was prepared to a final concentration of 1 μM each in MeOH. The mixture of atenolol and fendiline was prepared to a final concentration of 100 μM and 3 μM, respectively, in MeOH.

All samples were deposited onto a hydrophobic PTFE printed microscope slide (P/N: 50-292-18, Fisher Scientific) using a 2.5 μL Eppendorf® pipettor with a set volume of 2 μL. Note that the wells in the glass surface were not used as increased signal stability and intensity was observed when the samples were loaded onto the PTFE surface between the uncoated wells as indicated by the position of the x's in the left side of FIG. 1.

The DESI sprayer (also generally described for example in Takats et al., Science, 306:471-473, 2004 and U.S. Pat. No. 7,335,897, the content of each of which is incorporated by reference herein in its entirety) was made from a custom Swagelok T-union (Solon, OH, USA) and two different fused silica capillaries, manufactured by Polymicro, a subsidiary of Molex (Lisle, IL, USA). The inner solvent capillary (P/N: 1068150015, ID=50 μm, OD=150 μm) was inserted through the outer nebulizing capillary (P/N: 1068150026, ID=250 μm, OD=350 μm) such that it protruded 0.5 mm from the end of the nebulizing capillary. The DESI sprayer tip was held 4 mm above the array surface with an angle of incidence of 70 degrees from the horizontal. A home-made ion transfer tube (stainless steel, ID=0.9 mm, OD=1.6 mm) extended 10 cm from the front plane of the ion source and was bent downwards, 10 degrees from the horizontal, 17.5 mm from the inlet of the transfer tube (82.5 mm from the front plane of the source). To maximize signal intensity and reproducibility, the inlet of the transfer tube was made to gently rest on the analysis surface by raising the two-dimensional motorized stage and 3D printed sample holder once the sample was loaded (FIG. 1, right, depicts the complete assembly). Under these conditions, the impact point of the DESI spray was 2 mm in front of the ion transfer tube inlet. During operation, a solution of 1:1:0.0001 v/v/v MeOH:H₂O:FA was dispensed by a Harvard Apparatus® PHD 2000 syringe pump (Holliston, MA, USA) through the solvent capillary at a rate of 6 μL/min. The needle of the syringe was connected to the ESI source voltage of the instrument and biased to +6 kV. Nitrogen gas (100 psi) was allowed to flow through the gap between the inner and outer capillaries to pneumatically drive the charged droplet mist towards the analysis surface.

A two-dimensional (X/Z) translational moving stage was mounted to the front of the instrument and a 3D-printed slide holder was to secured to top of the stage, as seen in FIG. 1, right. In effect, this provided a location reference for the DESI sample slide relative to the inlet of the instrument and the sprayer. Each of the two translational axes were driven with a bipolar stepper motor (P/N: QSH4218-41-10-035, Trinamic, Hamburg, Germany) and had a movable range of 80 mm (+40 mm from center). The combination of stepper motor and pitch of the threaded shaft gave a translational resolution of 625 nm per micro-step ( 1/16 of a full step) with a maximum speed of ~6.25 mm/s. It should be noted that the translational resolution of the stage was estimated by moving the stage 80,000 microsteps and measuring the true distance moved (50.0 mm). For the purposes of this study, both motors were operated at a low speed of 5 mm/s (constant) to reduce the chances of a missed step and to ensure the specified position was accurate to less than 0.1 mm.

An open-source electronic prototyping platform, equipped with a RAMPS 1.4 shield and several A4988 stepper motor drivers, was used to control the direction, position, and speed of both motors. A do-it-yourself (DIY) 3D printing kit containing all necessary parts was purchased directly from Amazon.com. Prior to installing each A4988 driver module, jumpers were placed across all step resolution terminals on the RAMPS board so that all motors operated in micro-stepping mode ( 1/16 of a full step). The X and Z motor outputs were wired to their respective motors on the moving stage and the A4988 module potentiometer was adjusted to provide a current of 1 A to each phase of the motors. The following website provides an introduction to the use of the A4988 module with an Arduino: https://lastminuteengineers.com/a4988-stepper-motor-driver-arduino-tutorial/(accessed: Nov. 8, 2022).

The code installed on the Arduino Mega microcontroller is a derivative of momostein's RAMPS library on GitHub which has been modified to operate on serial commands, either from the serial monitor in the Arduino IDE (v1.8.19), or from MATLAB. As an example, sending “SET,X,POSITION,10” to the Arduino would move the stage to position X=10 mm. The number of micro-steps and direction that the motor should travel is calculated on-board based on the programmed resolution of the stage (mm/micro-step), the driver resolution mode ( 1/16), and its current position. Several more advanced functions were added to the library which allowed for multi-dimensional stage movement (e.g. diagonal) and stage oscillation during data acquisition.

The stage movement workflow was defined in an Excel worksheet, where users could specify how to move the stage, when to collect data, what to do during data acquisition, etc. This sheet was imported into a custom MATLAB (R2021b) graphical user interface (GUI) through a COM object, which interpreted the rows of instructions and built a serial command list. This GUI was responsible for establishing communication with the Arduino, verifying its presence at runtime, initializing the on-board motor parameters (e.g. step resolution), and verifying the workflow against the stage limits (e.g. maximum X position of the workflow is not outside of the working range of the stage). From this GUI, the user can also send individual commands to the Arduino or run the workflow independently from data acquisition to verify the movement of the stage prior to running samples.

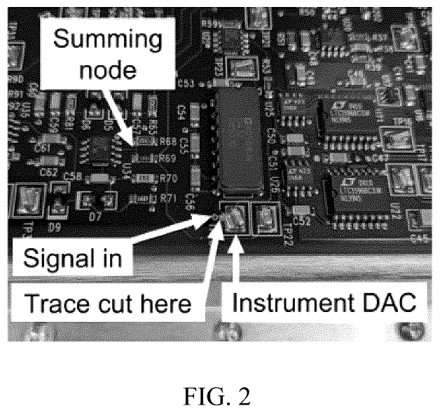

All experiments were performed using a Thermo Scientific LTQ XL (San Jose, CA, USA) modified for 2D-MS/MS analysis, as described previously (Szalwinski et al., Analyst, 147 (2022) 940-946; Snyder et al., Anal. Chem., 89 (2017) 8148-8155; and Szalwinski et al., Anal. Chem., (2020) 10016-10023, each of which is incorporated by reference herein in its entirety). In brief, the linear ion trap (LIT) radiofrequency (RF) voltage level, supplementary alternating current applied to the x-rods (ACₓ, product ejection), and supplementary alternating current applied to the y-rods (AC_{y}, precursor fragmentation) were controlled via two Keysight 33612A arbitrary waveform generators (Keysight Technologies Inc., Santa Rosa, CA, USA) with 64 MSa memory upgrades. Both waveform generators were triggered simultaneously at the beginning of ion injection (scan position=0) by the instruments output trigger (3.3V) on the digital control board. To ensure that there was only one output trigger per scan, the instrument automatic gain control (AGC) was disabled. To enable RF control, the trace between the electrical via and TP25 on the top RF detector board was severed (FIG. 2). This effectively removes the instrument DAC (U21=LTC1596 and U25=LT1468) such that a signal can be injected from an external source at the electrical via to control the RF reference level at the summing node. Through this test-point, the RF reference level was pulsed to a constant 460 mV (HighZ, period=950 ms, duty cycle=99%, edge time=4 ns, burst count=1). The high period was made longer than the 2D-MS/MS scan (900 ms) to ensure that ions were trapped for the entire analysis period, while the low period effectively dumps ions from the trap prior to the next injection.

Both arbitrary waveforms, ACₓ and AC_{y}, were calculated in MATLAB R2021b (The MathWorks Inc., Natick, MA, USA) and downloaded to their respective channels of the waveform generators as binary data using MATLAB's instrument control toolbox. ACₓ (qₛₜₐᵣₜ=0.908046, q_{end}=0.2, scan time=900 ms, fₛ=5 MSa/s, 2 Vpp, 50Ω, burst count=1) was applied through the normal RCA input of the low-pass filter box. AC_{y} was created by mimicking the OEM modifications to coil box and low pass filter which originally permitted a supplementary AC to be added across the x-rods. Then, AC_{y} (qₛₜₐᵣₜ=0.908046, q_{end}=0.18, scan time=900 ms, fₛ=5 MSa/s, 1 Vpp, 50Ω, burst count=1) was included through an additional BNC connector to the low-pass filter box.

The instrument was operated in the positive mode with a spray voltage of +6 kV, capillary voltage of +8 V, capillary temperature of 275° C., and tube lens voltage of +60 V, while the rest of the ion path voltages were set automatically by the instrument without any adjustment. In the scan definition dialog of the Tune Plus software (v2.7.0.1103 SP1, Thermo Fisher Scientific Inc., Waltham, MA), the following parameters were set: injection time=200 ms, mass range=“high”, scan rate=“zoom”, first mass (m/z)=100, last mass (m/z)=230. These conditions yielded an overall instrument-determined scan time of 1.19 seconds. To improve the sensitivity and fragmentation efficiency, nitrogen was used instead of helium as the bath gas, and the main chamber pressure was maintained at an uncalibrated reading of 1.6×10⁻⁵ Torr by a Granville-Phillips Variable Leak Valve (Model 203, Boulder, CO, USA). The electron multiplier output was amplified by a LTC6268-10 (TZ gain=5 k) transimpedance amplifier (TIA), filtered through two sequential, active, 2^{nd} order low-pass filters (f_{c}=250 kHz), and voltage amplified by a factor of 10. The final signal was digitized by a PicoScope 5444D (St Neots, Cambridgeshire, UK) (Z_{IN}=1 MΩ, fₛ=500 kHz, post trigger samples=450001, range=±5 V, vertical resolution=16 bit, coupling=AC, bandwidth limit=on, external trigger). All spectra presented herein are the average of three individual acquisitions.

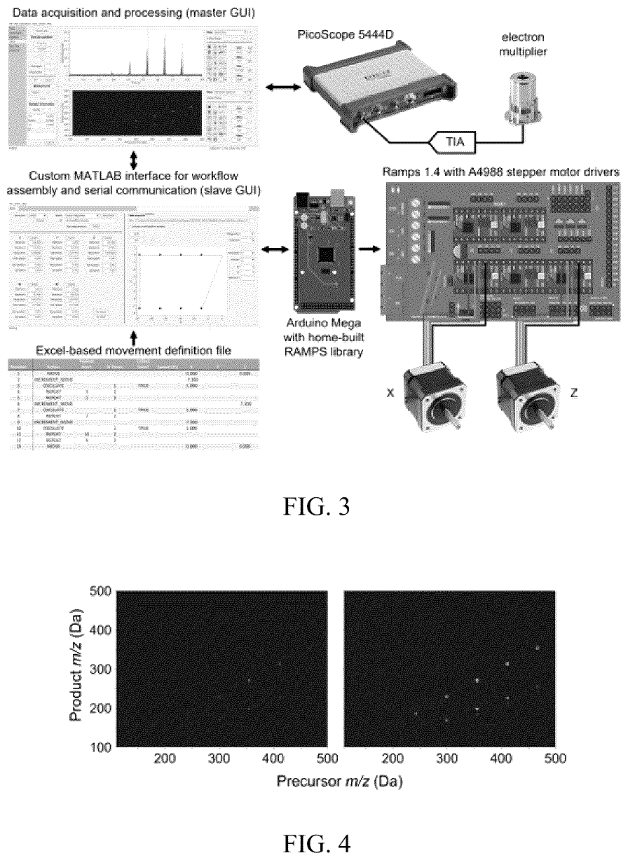

A representation of the hardware/software integration used throughout this work is shown in FIG. 3. In brief, a master graphical user interface (GUI), designed in MATLAB R2021b (The MathWorks Inc., Natick, MA, USA), was modified to control the timing and flow of data acquisition/processing throughout the experiment. The master GUI interfaces with the PicoScope through the PicoSDK (https://www.picotech.com/downloads/_lightbox/pico-software-development-kit-64 bit, accessed: Nov. 8, 2022) and performs the initial setup of the digitizer parameters (voltage range, sampling rate, number of samples, etc.). Similarly, as described in section 2.3, the slave GUI interfaces with the Arduino Mega and subsequent stepper motors through a serial interface. When opened from the master data acquisition GUI, the slave GUI exposes its application programming interface (API) thereby giving the master GUI complete control of the stage workflow and the stepper motors.

At runtime, when the full experiment is initiated on the data acquisition GUI, control is passed to the slave GUI which sends position update commands to the Arduino until a workflow segment is reached where data acquisition is to take place. Once the Arduino acknowledges that the motors are in the correct place for data acquisition, the slave GUI sends the Arduino a command to oscillate about the DESI spot, if applicable, and immediately returns control to the master GUI. From here, the PicoScope is instructed to collect a spectrum, after which the data is transferred back to the master GUI and processed. This cycle is repeated for the entirety of the experiment, with the active control continuously being passed back and forth between the PicoScope, master GUI, slave GUI, and Arduino, much like the ball in the old arcade game ‘Pong’.

All additional 2D-MS/MS data processing was performed in the master data acquisition/processing GUI once it was received from the PicoScope. The averaged 1D raw data was reshaped by splitting the recorded time domain into equal length segments corresponding to the duration of a single product ion sweep (1.5 ms). Each of the product ion spectra were then placed into their respective 2D table column to generate an image. Under the RF and AC conditions set forth in section 2.4, the raw 2D time-domain spectral image was linearly calibrated according to the following equations:

$$precursor\_Th = precursor\_scan \_rate \_Th / s \cdot time\_s + precursor\_intercept \qquad ( 1 )$$

$$precursor\_Th = precursor\_scan \_rate \_Th / s \cdot time\_s + product\_intercept \qquad ( 2 )$$

where precursor_scan_rate_Th/s=415.50, precursor_intercept=86.95, product_scan_rate_Th/s=221000, and product_intercept=76.44. In the case of the precursor calibration, time_s represents the time at which the product ion sweep started, whereas time_s in the product ion calibration represents the time since the beginning of each respective product ion sweep. Higher order calibrations could be performed to increase the mass accuracy, especially in the product ion domain, however that it outside the scope of the current work.

Each 2D-MS/MS spectrum was visualized using MATLAB's built-in tonemap function from the image processing toolbox (number of tiles=75×60, colormap=‘viridis’ from https://www.mathworks.com/matlabcentral/fileexchange/51986-perceptually-uniform-colormaps (accessed Nov. 8, 2022)). Tone mapping seeks to maximize the local contrast within each tile to approximate a high-dynamic-range image in a low-dynamic-range medium. The effect of tone-mapping can be seen in FIG. 4, where low intensity peaks are more easily visualized against the dark background. The number of tiles was chosen such that each individual tile was similar in dimensions to a single peak in the 2D spectrum, thereby allowing neighboring peaks to be enhanced. It is worth noting that tone-mapping only affects the perceived color of the displayed image; it does not change the intensity values of the underlying dataset.

The integrated hardware and software, described in the experimental section, was used to automatically collect, and analyze a sample slide by DESI-2D-MS/MS that contained six spotted samples across eight different collection points (FIG. 1A, left). A TAA mixture was loaded in positions 1 and 5, an atenolol/fendiline mixture in positions 2 and 6, and a fentanyl mixture in positions 3 and 7, while positions 4 and 8 were left as blanks. The unique way in which the hardware and software interact ensures that data acquisition is performed at the specified point on the moving stage surface, thereby enabling DESI imaging 2D-MS/MS for future applications. Here, at each collection point, three spectra were acquired and averaged while the stage was continuously oscillated±0.5 mm from the defined spot center. This oscillatory motion was a proactive measure to help increase spectral reproducibility by mitigating the so-called ‘coffee ring’ effect, wherein spotted samples show higher concentration of the analyte around the outer edge of the dried spot.

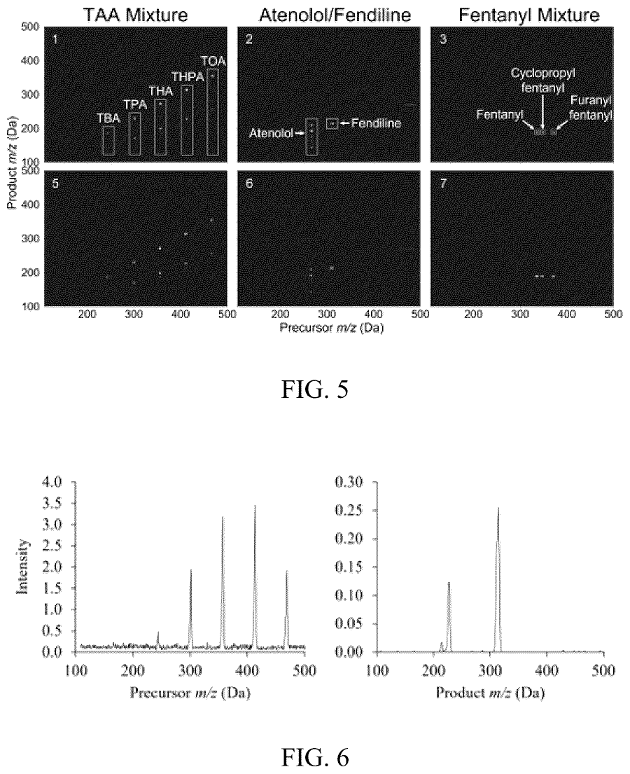

FIG. 5 shows the 2D-MS/MS spectra resulting from the analysis, where the number in the upper left of each image indicates the slide position at which it was recorded. Note that spectra 4 and 8 (blanks) were omitted for clarity as they did not contain any signal. Each spectrum contains clearly identifiable product ion spectra at the precursor ion mass-to-charge ratio, with no observable carryover or cross-contamination between spots. The replicate pairs, defined by the upper and lower rows in the figure, demonstrate good reproducibility between samples spotted on the PTFE surface. In total, this analysis, consisting of 24 spectra collected across 8 spots, required 64 seconds complete, which could be reduced by a factor of two with a faster stage and parallelized operations. FIG. 6 shows how one might obtain a traditional MS¹ or MS² spectrum from the two-dimensional datasets of FIG. 5.

There are two related items which made this analysis particularly challenging. When considering the small (~nanogram) sample deposits, and that DESI is a relatively insensitive technique (200 ms injection time used here vs. <5 ms using nano-electrospray ionization for the same concentration), the DESI spray itself quickly depletes the sample from the drop-casted spot. In this work, the spray was not removed from the collection spot when ions were not being accumulated in the linear ion trap. Had the spray been removed during this time (data acquisition, data transfer, processing, image update, handshaking, etc.) it may have been possible to delay sample depletion effects by a factor of five, thereby increasing the intensity of subsequent replicates and the number of averages one could collect. Of course, this is only an option when the density of the sample points is low enough that the spray can be moved between spots without interference. The second item is that modifying the instrument to have detection performed by our custom transimpedance amplifier required the removal of the OEM detection electronics. In effect, this made the instrument blind to the magnitude of the ion signal, and it could not perform its normal automatic gain control (AGC) functions. Without AGC, even in this short analysis, the intensity of acquisition 3 was a factor of 2-3× lower than that of acquisition 1, likely due to challenge one above. Both items considered, each analysis had to be performed quickly, and the concentration of each mixture had to be individually tailored to provide a sufficiently high signal-to-noise ratio, and to minimize the number of averages required while not being high enough to incur space-charge related effects.

This study provides the first demonstration of the combination of 2D tandem mass spectrometry (2D-MS/MS), which captures all possible fragmentation data of the entire population of ions created in an ionization event, with high throughput ambient ionization by DESI-MS. The combination offers detailed untargeted information on the constituents of complex chemical mixtures. The instrument and data control system used in this study was designed for high positional accuracy which is needed for future high spatial resolution imaging and high-density array analysis, where the resolution is effectively limited by the DESI spot size at the analysis surface. While only 8 well-separated spot positions were analyzed in this work, the system has submicron mechanical precision which is sufficient to analyze 6144 well plates, which have spot diameters of ~850 μm and a center-to-center pitch of 1.125 mm. Additionally, the Arduino can be programmed with other advanced geometric functions (spiral, circle, etc.) as a means of improving the accuracy of spot-to-spot 2D-MS/MS measurements. The weaknesses of the system are the relatively lower ion currents available from DESI vs. for example, nanospray, however, high speed, high spatial resolution nanospray is not possible. The relatively low mass resolution of 2D-MS/MS is a second weakness which must be balanced against the strength of the method in terms of throughput and the depth of unsupervised chemical coverage.

### Desorption Electrospray Ionization

Desorption electrospray ionization (DESI) is described for example in Takats et al. (U.S. Pat. No. 7,335,897), the content of which is incorporated by reference herein in its entirety. DESI allows ionizing and desorbing a material (analyte) at atmospheric or reduced pressure under ambient conditions. A DESI system generally includes a device for generating a DESI-active spray by delivering droplets of a liquid into a nebulizing gas. The system also includes a means for directing the DESI-active spray onto a surface. It is understood that the DESI-active spray may, at the point of contact with the surface, include both or either charged and uncharged liquid droplets, gaseous ions, molecules of the nebulizing gas and of the atmosphere in the vicinity. The pneumatically assisted spray is directed onto the surface of a sample material where it interacts with one or more analytes, if present in the sample, and generates desorbed ions of the analyte or analytes. The desorbed ions can be directed to a mass analyzer for mass analysis, to an IMS device for separation by size and measurement of resulting voltage variations, to a flame spectrometer for spectral analysis, or the like.

In this system, a spray is generated by a conventional electrospray device. The device includes a spray capillary through which the liquid solvent is fed. A surrounding nebulizer capillary forms an annular space through which a nebulizing gas such as nitrogen (N₂) is fed at high velocity. In one example, the liquid was a water/methanol mixture and the gas was nitrogen. A high voltage is applied to the liquid solvent by a power supply via a metal connecting element. The result of the fast-flowing nebulizing gas interacting with the liquid leaving the capillary is to form the DESI-active spray comprising liquid droplets. DESI-active spray also may include neutral atmospheric molecules, nebulizing gas, and gaseous ions. Although an electrospray device has been described, any device capable of generating a stream of liquid droplets carried by a nebulizing gas jet may be used to form the DESI-active spray.

The spray is directed onto the sample material which in this example is supported on a surface. The desorbed ions leaving the sample are collected and introduced into the atmospheric inlet or interface of a mass spectrometer for analysis by an ion transfer line which is positioned in sufficiently close proximity to the sample to collect the desorbed ions. Surface may be a moveable platform or may be mounted on a moveable platform that can be moved in the x, y or z directions by well-known drive means to desorb and ionize sample at different areas, sometimes to create a map or image of the distribution of constituents of a sample. Electric potential and temperature of the platform may also be controlled by known means. Any atmospheric interface that is normally found in mass spectrometers will be suitable for use in the invention. Good results have been obtained using a typical heated capillary atmospheric interface. Good results also have been obtained using an atmospheric interface that samples via an extended flexible ion transfer line made either of metal or an insulator.

### Ion Traps and Mass Spectrometers

Any ion trap known in the art can be used in systems of the invention. Exemplary ion traps include a hyperbolic ion trap (e.g., U.S. Pat. No. 5,644,131, the content of which is incorporated by reference herein in its entirety), a cylindrical ion trap (e.g., Bonner et al., International Journal of Mass Spectrometry and Ion Physics, 24(3):255-269, 1977, the content of which is incorporated by reference herein in its entirety), a linear ion trap (Hagar, Rapid Communications in Mass Spectrometry, 16(6):512-526, 2002, the content of which is incorporated by reference herein in its entirety), and a rectilinear ion trap (U.S. Pat. No. 6,838,666, the content of which is incorporated by reference herein in its entirety).

Any mass spectrometer (e.g., bench-top mass spectrometer of miniature mass spectrometer) may be used in systems of the invention and in certain embodiments the mass spectrometer is a miniature mass spectrometer. An exemplary miniature mass spectrometer is described, for example in Gao et al. (Anal. Chem. 2008, 80, 7198-7205.), the content of which is incorporated by reference herein in its entirety. In comparison with the pumping system used for lab-scale instruments with thousands of watts of power, miniature mass spectrometers generally have smaller pumping systems, such as a 18 W pumping system with only a 5 L/min (0.3 m3/hr) diaphragm pump and a 11 L/s turbo pump for the system described in Gao et al. Other exemplary miniature mass spectrometers are described for example in Gao et al. (Anal. Chem., 2008, 80, 7198-7205.), Hou et al. (Anal. Chem., 2011, 83, 1857-1861.), and Sokol et al. (Int. J. Mass Spectrom., 2011, 306, 187-195), the content of each of which is incorporated herein by reference in its entirety.

The control system of the Mini 12 (Linfan Li, Tsung-Chi Chen, Yue Ren, Paul I. Hendricks, R. Graham Cooks and Zheng Ouyang “Miniature Ambient Mass Analysis System” Anal. Chem. 2014, 86 2909-2916, DOI: 10.1021/ac403766c; and 860. Paul I. Hendricks, Jon K. Dalgleish, Jacob T. Shelley, Matthew A. Kirleis, Matthew T. McNicholas, Linfan Li, Tsung-Chi Chen, Chien-Hsun Chen, Jason S. Duncan, Frank Boudreau, Robert J. Noll, John P. Denton, Timothy A. Roach, Zheng Ouyang, and R. Graham Cooks “Autonomous in-situ analysis and real-time chemical detection using a backpack miniature mass spectrometer: concept, instrumentation development, and performance” Anal. Chem., 2014, 86 2900-2908 DOI: 10.1021/ac403765x, the content of each of which is incorporated by reference herein in its entirety), and the vacuum system of the Mini 10 (Liang Gao, Qingyu Song, Garth E. Patterson, R. Graham Cooks and Zheng Ouyang, “Handheld Rectilinear Ion Trap Mass Spectrometer”, Anal. Chem., 78 (2006) 5994-6002 DOI: 10.1021/ac061144k, the content of which is incorporated by reference herein in its entirety) may be combined to produce the miniature mass spectrometer shown in FIG. 9. It may have a size similar to that of a shoebox (H20 cm×W25 cm×D35 cm). In certain embodiments, the miniature mass spectrometer uses a dual LIT configuration, which is described for example in Owen et al. (U.S. patent application Ser. No. 14/345,672), and Ouyang et al. (U.S. patent application Ser. No. 61/865,377), the content of each of which is incorporated by reference herein in its entirety.

### System Architecture

In certain embodiments, the systems and methods of the invention can be carried out using automated systems and computing devices. Specifically, aspects of the invention described herein can be performed using any type of computing device, such as a computer, that includes a processor, e.g., a central processing unit, or any combination of computing devices where each device performs at least part of the process or method. In some embodiments, systems and methods described herein may be controlled using a handheld device, e.g., a smart tablet, or a smart phone, or a specialty device produced for the system.

Systems and methods of the invention can be performed using software, hardware, firmware, hardwiring, or combinations of any of these. Features implementing functions can also be physically located at various positions, including being distributed such that portions of functions are implemented at different physical locations (e.g., imaging apparatus in one room and host workstation in another, or in separate buildings, for example, with wireless or wired connections).

Processors suitable for the execution of computer program include, by way of example, both general and special purpose microprocessors, and any one or more processor of any kind of digital computer. Generally, a processor will receive instructions and data from a read-only memory or a random access memory or both. The essential elements of computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, solid state drive (SSD), and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having an I/O device, e.g., a CRT, LCD, LED, or projection device for displaying information to the user and an input or output device such as a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected through network by any form or medium of digital data communication, e.g., a communication network. For example, the reference set of data may be stored at a remote location and the computer communicates across a network to access the reference set to compare data derived from the female subject to the reference set. In other embodiments, however, the reference set is stored locally within the computer and the computer accesses the reference set within the CPU to compare subject data to the reference set. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript.

A computer program does not necessarily correspond to a file. A program can be stored in a file or a portion of file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over a network (e.g., as packets being sent from a server to a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user. In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file are well-known in the art and, for example, can be invoked manually or automatically by a program or by a save command from software or a write command from a programming language.

Suitable computing devices typically include mass memory, at least one graphical user interface, at least one display device, and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD) or other optical storage, magnetic cassettes, magnetic tape, magnetic disk storage or other magnetic storage devices, Radiofrequency Identification tags or chips, or any other medium which can be used to store the desired information and which can be accessed by a computing device.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

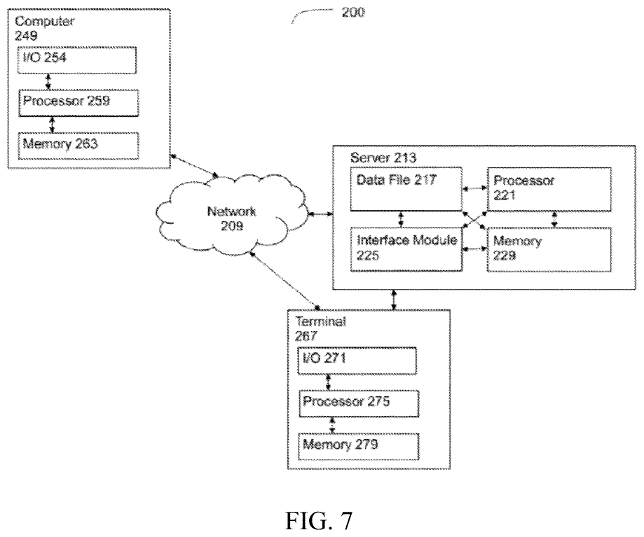

In an exemplary embodiment shown in FIG. 7, system 200 can include a computer 249 (e.g., laptop, desktop, or tablet). The computer 249 may be configured to communicate across a network 209. Computer 249 includes one or more processor 259 and memory 263 as well as an input/output mechanism 254. Where methods of the invention employ a client/server architecture, steps of methods of the invention may be performed using server 213, which includes one or more of processor 221 and memory 229, capable of obtaining data, instructions, etc., or providing results via interface module 225 or providing results as a file 217. Server 213 may be engaged over network 209 through computer 249 or terminal 267, or server 213 may be directly connected to terminal 267, including one or more processor 275 and memory 279, as well as input/output mechanism 271.

System 200 or machines according to the invention may further include, for any of I/O 249, 237, or 271 a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Memory 263, 279, or 229 according to the invention can include a machine-readable medium on which is stored one or more sets of instructions (e.g., software) embodying any one or more of the methodologies or functions described herein. The software may also reside, completely or at least partially, within the main memory and/or within the processor during execution thereof by the computer system, the main memory and the processor also constituting machine-readable media. The software may further be transmitted or received over a network via the network interface device.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein

What is claimed is:

1. An automated sample analysis system comprising:
a desorption electrospray ionization (DESI) probe;
a substrate for holding one or more samples;
a mass spectrometer; and
one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition.

2. The automated sample analysis system of claim 1, wherein the one or more programs control timing and flow of data acquisition/processing throughout data acquisition.

3. The automated sample analysis system of claim 2, wherein the one or more programs ensure that data acquisition is performed at a specified point on the substrate.

4. The automated sample analysis system of claim 3, wherein at each collection point, three spectra are acquired and averaged while the substrate is continuously oscillated from a defined spot center.

5. The automated sample analysis system of claim 4, wherein the oscillatory motion increases spectral reproducibility by mitigating a coffee ring effect, wherein spotted samples show higher concentration of an analyte around an outer edge of a dried spot

6. The automated sample analysis system of claim 2, wherein upon completion of raw data acquisition, the one or more programs average one-dimensional raw data so that it is reshaped by splitting a recorded time domain into equal length segments corresponding to a duration of a single product ion sweep to generate product ion spectra.

7. The automated sample analysis system of claim 6, wherein each of the product ion spectra are then placed into their respective two-dimensional table column to generate an image.

8. The automated sample analysis system of claim 7, wherein each two-dimensional time-domain spectral image was calibrated for precursor and product ion mass/charge ratio from recorded peak positions, sweep time, and/or precursor or product scan rate.

9. The automated sample analysis system of claim 1, wherein the automated sample analysis system comprises a plurality of controllers, each associated with a different aspect of the system and each in communication with each other.

10. The automated sample analysis system of claim 9, wherein one of the plurality of controllers is a master controller.

11. A method for automated sample analysis, the method comprising:
providing an automated sample analysis system comprising a desorption electrospray ionization (DESI) probe; a substrate for holding one or more samples; a mass spectrometer; and one or more controllers, wherein the one or more controllers are operably associated with each other and at least one of the DESI probe, the substrate, and/or the mass spectrometer, and the one or more controllers are each configured to execute one or more programs that cause acquisition of two-dimensional tandem mass spectrometry (2D-MS/MS) data domains via synchronous operation of the DESI probe with movement of the substrate along with the 2D-MS/MS data acquisition, thereby ensuring automated correct time and position for 2D-MS/MS data acquisition; and
operating the system to analyze one or more samples and generated a 2D-MS/MS image for each sample in an automated and synchronized manner.

12. The method of claim 11, wherein the one or more programs control timing and flow of data acquisition/processing throughout data acquisition.

13. The method of claim 12, wherein the one or more programs ensure that data acquisition is performed at a specified point on the substrate.

14. The method of claim 3, wherein at each collection point, three spectra are acquired and averaged while the substrate is continuously oscillated from a defined spot center.

15. The method of claim 14, wherein the oscillatory motion increases spectral reproducibility by mitigating a coffee ring effect, wherein spotted samples show higher concentration of an analyte around an outer edge of a dried spot

16. The method of claim 12, wherein upon completion of raw data acquisition, the one or more programs average one-dimensional raw data so that it is reshaped by splitting a recorded time domain into equal length segments corresponding to a duration of a single product ion sweep to generate product ion spectra.

17. The method of claim 16, wherein each of the product ion spectra are then placed into their respective two-dimensional table column to generate an image.

18. The method of claim 17, wherein each two-dimensional time-domain spectral image was calibrated for precursor and product ion mass/charge ratio from recorded peak positions, sweep time, and/or precursor or product scan rate.

19. The method of claim 11, wherein the automated sample analysis system comprises a plurality of controllers, each associated with a different aspect of the system and each in communication with each other.

20. The method of claim 19, wherein one of the plurality of controllers is a master controller.
